(19) United States
(12) Patent Application Publication
(10) Pub. No.: US 2017/0132225 A1
(43) Pub. Date: May 11, 2017

(54) STORING AND RETRIEVING ASSOCIATED INFORMATION WITH A DIGITAL IMAGE

(71) Applicant: Leigh M. ROTHCHILD, Sunny Isles Beach, FL (US)

(72) Inventor: Leigh M. ROTHCHILD, Sunny Isles Beach, FL (US)

(73) Assignee: Ariel invention, LLC, Sunny Isles Beach, FL (US)

(21) Appl. No.: 15/413,350

(22) Filed: Jan. 23, 2017

Related U.S. Application Data
(63) Continuation of application No. 13/596,405, filed on Aug. 28, 2012.
Application No. 13/596,405 is a continuation of application No. 12/884,941, filed on Sep. 17, 2010, now abandoned.
Application No. 12/884,941 is a continuation-in-part of application No. 12/290,066, filed on Oct. 27, 2008, now Pat. No. 7,995,118.
Application No. 12/290,066 is a continuation of application No. 10/998,691, filed on Nov. 29, 2004, now Pat. No. 7,450,163.
Application No. 12/884,941 is a continuation-in-part of application No. 12/290,258, filed on Oct. 29, 2008, now Pat. No. 8,854,499.
Application No. 12/290,258 is a continuation of application No. 11/051,069, filed on Feb. 4, 2005, now Pat. No. 7,456,872.
Application No. 11/051,069 is a continuation-in-part of application No. 11/020,459, filed on Dec. 22, 2004, now abandoned.
Application No. 11/020,459 is a continuation-in-part of application No. 10/998,691, filed on Nov. 29, 2004, now Pat. No. 7,450,163.

(51) Int. Cl. G06F 17/30; H04N 1/00; H04N 1/32

(52) U.S. Cl. CPC G06F 17/3028; H04N 1/32128; H04N 1/00344; G06F 17/30256; G06F 17/30047; H04N 2201/0039; H04N 2201/3205; H04N 2201/3214; H04N 2201/3215; H04N 2201/3221; H04N 2201/3208; H04N 2201/3229; H04N 2201/3249; H04N 2201/3252; H04N 2201/3253; H04N 2201/3264; H04N 2201/3266; H04N 2201/3267; H04N 2201/3274

(57) ABSTRACT

A method and apparatus for processing metadata of an image are disclosed. The metadata is associated with the image and an applet views the metadata in response to selection of the image. The metadata may include links to websites, audio files, video files, and text files, as well as image capture information including GPS location, time and date of capture, camera settings, etc. In response to selection of the image, or in response to arriving at a website pointed to by a URL in the metadata, a list of information materials associated with the image may be displayed. One or more of the information materials may be automatically activated.

### CROSS-REFERENCE TO RELATED APPLICATIONS

This application is a continuation of U.S. patent application Ser. No 13/596,405, filed Aug. 28, 2012. This application is also a continuation-in-part-of U.S. patent application Ser. No. 12/290,066, filed Oct. 27, 2008 which is a continuation of U.S. patent application Ser. No. 10/998,691, filed Nov. 29, 2004, now U.S. Pat. No. 7,450,163, the entirety of which is incorporated herein by reference. This application is also a continuation in part of U.S. patent application Ser. No. 12/290.258, tiled on Oct. 29, 2008, the entirety of which is incorporated herein by reference, and which is a continuation of U.S. patent application Ser. No. 11/051,069, filed on Feb. 4, 2005, now U.S. Pat. No. 7,456,872, the entirely of which is incorporated herein by reference, and which is a continuation in part of U.S. patent application Ser. No. 11/020,459, filed on Dec. 22, 2004, the entirety of which is incorporated herein by reference, and which is a continuation in part of U.S. patent application Ser. No. 10/998,691 filed on Nov. 29, 2004, now U.S. Pat. No. 7,450,163, the entirety of which is incorporated herein by reference. This application is also a continuation-in-part of U.S. patent application Ser. No. 12/860,404, filed on Aug. 20, 2010, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method and system for managing digital images, and more particularly to a method and system for associating data with a digital image.

### BACKGROUND OF THE INVENTION

Millions of images are captured each day by individuals around the globe. Many of these images are stored in the local storage or external storage of a computer, from which they can be accessed and viewed at any time after image capture. Many of these digital images are uploaded to websites on the World Wide Web (WWW), i.e., the Internet. On the Web, other users can access and view the images. In many cases the user can also click on the image and be directed to a different part of a website or to a totally different website.

Digital images that are routinely captured usually contain embedded metadata that contain information about the digital image. This metadata is automatically written by the photographic device that captures the image. This metadata may include user supplied information that is stored prior to image capture and may also include metadata automatically supplied by the image capture device, including geographic location, date and time of image capture, width, length, resolution, pim information, compression information, f-number, etc. This information may be made available to anyone who desires additional information about the image or the image's author, i.e. creator.

Currently, an Internet user cannot easily access metadata for digital images once the digital image has been uploaded to a website. Further, the image author or other person processing the image cannot associate other information materials (such as text files, audio files, video files, URL hyperlinks, etc.) with an image that can be easily accessed once the image is uploaded on the Web. Further, known methods do not allow the associated information materials to stay associated with the digital image by having the information permanently linked to the image so that no matter where the image may be stored, any party can access the associated information materials.

What is needed is a method and system for easily associating additional metadata and information materials with an image uploaded to the Web, accessing the metadata and information materials once the image is uploaded, and linking the metadata and information materials to the uploaded image.

### SUMMARY OF THE INVENTION

The present invention advantageously provides a method and system for processing metadata and other information materials associated with a digital image. In accordance with one aspect, metadata is associated with the image, and an applet is provided to view the metadata in response to selection of the image, and to retrieve from the metadata a uniform resource locator (URL) that points to a memory location of information materials related to the image.

In accordance with another aspect, the present invention provides a computer readable medium, containing computer readable instructions, that when executed by the computer, cause the computer to store metadata and additional information materials associated with an image, evaluate the metadata, and link to the additional information materials.

In accordance with another aspect, the present invention provides an apparatus for processing metadata of an image. The apparatus includes memory and a processor. The memory stores metadata and additional information materials that is associated with the image. The processor examines the metadata and links to the additional information materials.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a system constructed in accordance with the principles of the present invention;

FIG. 2 shows an exemplary computer for processing metadata in accordance with the principles of the present invention;

FIG. 3 is a flow chart of a process of associating metadata with an image and uploading the metadata and the image to a server; and

FIG. 4 is a flow chart of a process of viewing and displaying metadata in connection with an image.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for managing digital images. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

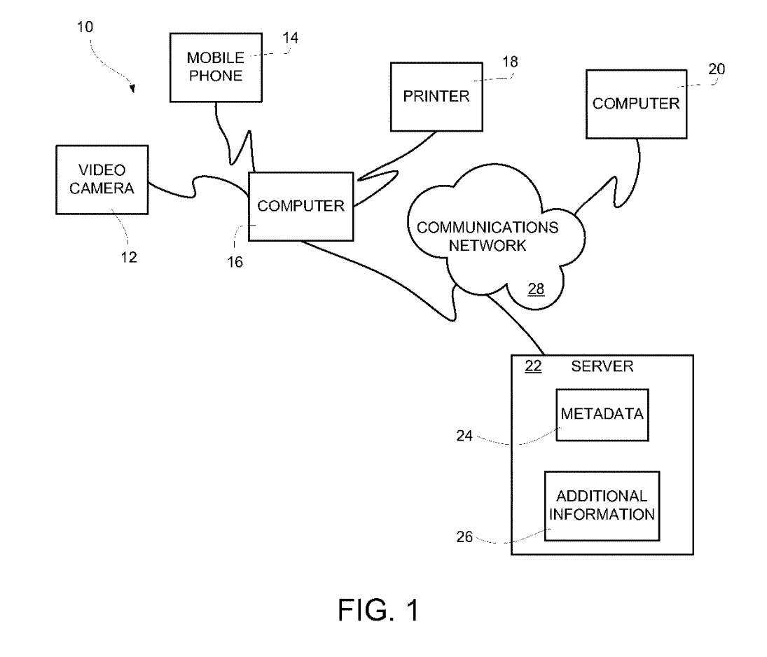

Referring now to the drawing figures in which reference designators refer to like elements, there is shown in FIG. 1 a block diagram of an exemplary system constructed in accordance with the principles of the present invention and designated generally as “10”. System 10 stories, transfers, and processes digital images, as well as metadata and additional information materials associated with the digital images. System 10 includes a camera 12 and/or a mobile phone 14 (referred to collectively as a Mobile Image Capture Device (MICD)) as well as a computer 16, a printer 18, a computer 20 and a server 22. Although FIG. 1 shows a single one of each of these devices, it is understood that more than one of these devices may be present. A digital image may be captured by the Mobile Image Capture Device (MICD). MICDs may include, for example, the IPHONE by APPLE, ANDROID phones by GOOGLE, and other devices from other manufacturers.

The MICD can be linked to a computer 16, wirelessly or by wired/optical connection, to transfer a captured digital image and metadata associated with the image from the MICD 12 or 14 to the computer 16. Image and metadata transfer may be automatic or in response to input by a user of the MICD. Thus, the MICD may include a transmission module that implements cellular, WiFi, satellite, infrared, cable, Local Area Network (LAN), or other communications technology to transfer the image and its metadata to the computer 16. The computer 16 may be a laptop or desktop computer or portable computing device, such as a personal digital assistant. The image and metadata can be printed by a printer 18 in communication with the computer 16.

As used herein, the term, “image,” includes a single captured image or a series of images, such as captured by a motion picture camera. The image may be stored as a jpg, bmp, tiff, avi, mpeg, rv, wmv, or other file type. The metadata associated with the image may also be stored as one of a known file type, and may include audio files (such as way, mp3, aiff, pcm, wma, etc.) The metadata of the image may be one of several standardized schemas for metadata, including EXIF, IPTC, XMP, Dublin Core and. Plus. At least one of the metadata fields contains a URL that may specify a location of information materials associated with the image. According to one embodiment, an address, such as a uniform resource locator (URL) where the image and associated information materials arc stored or may be accessed, is embedded in the metadata. This address may be stored by a user before or after image capture.

In some embodiments, metadata can be associated with the captured image by the camera 12 or mobile phone 14. Additional metadata can be associated with the captured image by the computer 16. For example, a first set of metadata can be associated with the image by the MICD 12 or 14. This first set of metadata may be stored by a memory of the MICD. A second set of metadata can be associated with the image by the computer 16. This second set of metadata may be stored by a memory of the computer 16.

For example, the first set of metadata may include the creator's name, the time and date of capture of the image, an identification of the MICD that captured the image, characteristics of the image, including size, chroma, lighting, etc., the GPS coordinates of the MICD at the time of capture, the dimensions of the captured image, the f-number, resolution, compression information, an audio file, etc. Some of this first set of metadata may be input before image capture by the user of the MICD, and some of the first set of metadata, such as GPS coordinates, can be automatically determined by the MICD. Some or all of the metadata may be displayed at a display of the MICD, to allow the user to edit and approve the metadata.

The second set of metadata may include audio files, video files, uniform resource locators (URLs), a description of the captured image, information concerning image sizes, symbols such as barcodes, etc. Barcode data may be based, for example, on EAN, UPC, Code 25, Microsoft Tag, Neomedia Mobile Tag, QR Tags or the Shop Savvy Barcode system. For example, a bar code may be printed and/or decoded to provide information about the image to a user.

Some of the first set of metadata can be input at the MICD 12 or 14 and some or all of the second set of metadata can be associated with the image at the computer 16. The computer 16 can be connected to a server 22 via the Internet or other computer network 28, including the Public Switched. Telephone Network (PSTN). An image stored in the computer 16 can be copied, along with the metadata associated with the image, to the server 22. This transfer of the image and its metadata from the MICD or computer 16 to the server 22 may be performed at any time after image capture. In addition, the image and its metadata may be uploaded to the server 22 directly by the MILD 12 or 14. The server 22 stores metadata 24 and additional information materials 26 associated with the image.

Once uploaded, the image and its metadata may be accessible from the server 22 by another computer 20. Thus, in some embodiments, a file containing the image and its associated metadata can be uploaded to the server 22, where it can be accessed at a website accessible to a plurality of computers connected to the Internet. Note that the site containing the image and its metadata may not have any commercial nexus with the original author of the image, since ownership of the image may have been transferred or may be in the public domain. For example, an image uploaded to a social network site, such as FACEBOOK, may be in the public domain.

In some embodiments, an applet may be downloaded from a website at the request of a user. The applet enables a user to access or view metadata of an image. The website providing the applet may be different from the website where an image and its metadata are stored. The applet can automatically integrate into a web browser of the user or may remain separate. Current web browsers capable of integrating a downloaded applet include MICROSOFT INTERNET EXPLORER, GOOGLE'S CHROME, and MOZILLA FIREFOX, to name a few. The applet may be launched by clicking an icon provided on a tool bar of the web browser or may be launched by other input from the user.

When a user encounters a digital image of interest on the Web, he or she may select the image by clicking on the image, uttering a voice command, or otherwise indicating a selection of the image using a keyboard or mouse. The user may then launch the applet and a window may appear in response to launching the applet. The window may enable the user to view metadata or, alternatively, some or all of the metadata may be hidden from the user. The applet enables the user to view metadata by executing a metadata viewer to examine the metadata fields contained in the digital image file. Online metadata viewers include Jeffrey's Exif Viewer at http://regex.info./exif.cgi.

The applet may find and retrieve a URL within the metadata. This URL address may be an address or pointer to a location of a website or file that contains the metadata and other information materials associated with the image by a user. In one embodiment, the hyperlink could be a link to a server of a photo processing center. Examples of photo processing centers include WALMART, WALGREENS, COSTCO, FLICKR, and SONY IMAGESTATION among others. The metadata can then be processed at this center and the metadata may contain information concerning the type of processing requested by the owner of the images associated with the metadata.

Once the metadata viewer locates the URL address, the user may then be taken to the URL location either automatically or upon request. At the URL location, a thumbnail and/or a large size copy of the image may be presented to the user. Also, the user may be presented with a list of materials associated with the digital image. These materials may include audio files, video files, text files, URL links and hyper links to other related information, encoded symbology, GPS location information, variations of the image including higher definitions of the image or different sizes of the image. The user may then select any of the listed information to view or download.

Note that if there is only one type of material associated with the image, for example, a single audio file, then that file may be displayed, played, or activated automatically. Also, even if there are multiple materials associated with the image, anyone of them may be chosen to be activated automatically when the user selects the image. For example, a user may select an image and in response to the selection, a video file may automatically be played.

Thus, a user may capture an image using an MICD. The MICD may associate metadata with the image. The image and its metadata may be stored in a local memory of the MICD. A communications module of the MICD may transfer the image and its metadata to a local or remote computer or to external memory. The local or remote computer and the external memory may be connected to the Internet.

Once stored, a user (who may be different from the image author) may access the image at the storage location, and click on, or otherwise select the image. When the user selects the image, an applet may automatically be activated or may be activated upon selection by the user. As is discussed below, the metadata can be embedded as part of the image or stored separately. The activated applet may activate a metadata viewer to examine the metadata fields, including a URL field, contained in the digital image file that links to a website or file that has the image, the metadata, and information a user has associated with the image. The metadata viewer may enable offline or online viewing of the metadata.

Once the metadata viewer ascertains the URL of the location of the materials associated with the image, the user may be taken to the URL location automatically or upon request by the user. At that location, a thumbnail of the digital image may be shown to the user or alternatively a full size copy of the image may be displayed.

A list of information materials associated with the image may also be displayed. These information materials may include audio files, video files, text files, URLs and hyperlinks to other related information, encoded symbology, GPS location information, higher definitions of the image, and different sizes of the image. Note that one or more of these related information may be played, activated, or displayed automatically or upon selection by the user. The information materials to be activated automatically may be chosen in advance by an author of the image or another person. For example, if a user selects an image from a local memory and then requests information about the image, an audio file may automatically activate and play, thereby giving the audio information about the image. The audio information may include a verbal statement about the image and may include music chosen by the author of the image. As another example, a video file having information about the image may be activated automatically or upon selection. The information materials may also include multimedia files, e.g., files that combine audio and video.

Note also that the user may print out the image and its metadata, including, if selected, encoded symbology associated with the image. This symbology may be used by the MICD or a scanning device and may direct the user to the location of the image and its metadata. The user may also email the image and its metadata as a file attachment to an email. The user may also include a link in the email that points to a storage location of the image.

Thus, one embodiment is a method of processing metadata of a digital image. The method includes associating the metadata with the image, and providing an applet to view the metadata in response to selection of the image. The metadata may include a URL that links to a website. A browser may navigate to the website pointed to by the URL. The website may display a list of selectable information materials associated with the image. The information materials associated with the image may include an audio file, a video file, a text file, and/or an encoded symbol. At least one of the audio file, and the video file, may automatically be activated when the browser reaches the website indicated by the URL.

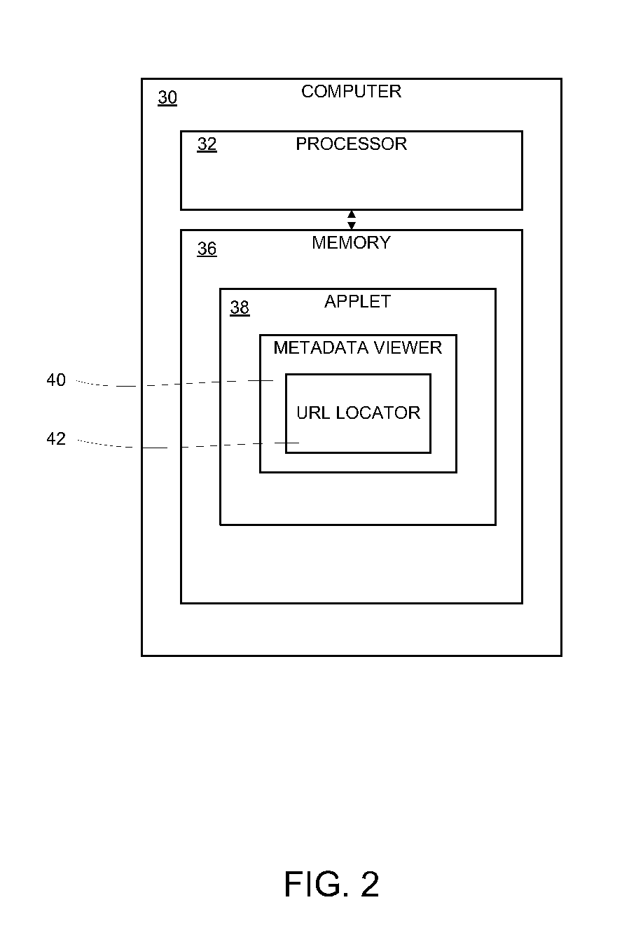

FIG. 2 shows a computer 30 having a processor 32 and memory 36 for processing metadata as described herein. The computer 30 may be a desktop computer, a laptop computer, a personal digital assistant, a mobile device, a tablet PC, etc. The computer 30 has a processor 32 for executing computer instructions stored in the memory 36. The memory 36 may be a hard drive, Random Access Memory (RAM), Read Only Memory (ROM), flash memory, compact disc, external memory, etc. Computer instructions stored in the memory 36 include an applet 38 which includes a metadata viewer 40, which has a URL locator 42 that extracts a URL from the metadata.

Thus, one embodiment is an apparatus for processing metadata of an image. The apparatus comprises a memory 36 and a processor 30. The memory 36 stores metadata in a memory location that is associated with the image. The processor 30 is operable to examine the metadata and perform an operation based on the metadata. For example, the operation performed by the processor 30 may cause the metadata to be displayed. The operation may include accessing a website addressed by a URL in the metadata. The operation may include storing the metadata in a memory location addressed by the metadata. The operation may include causing a list of information materials related to the image to be displayed.

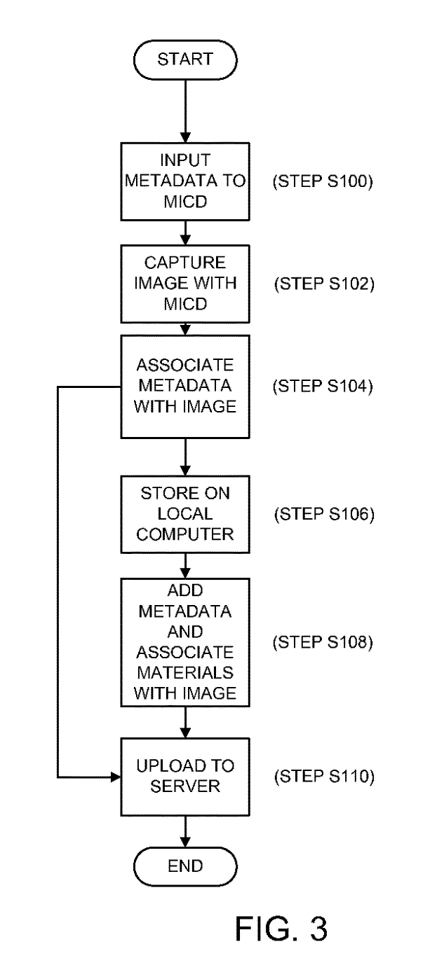

FIG. 3 is a flow chart of an exemplary process for associating metadata with an image. A user of an MICD inputs metadata to the MICD (Step S100). The metadata input by the user may include the user's name, address or email address, and phone number. The user captures an image by the MICD (Step S102). The MICD associates the image with metadata (Step S104). The metadata associated with the image by the MICD includes the metadata input by the user at Step S100, and may also include metadata automatically ascertained by the MICD. The metadata automatically ascertained by the MICD may include a make and model of the MICD,

GPS location at the time of image capture, time and date of image capture, camera settings such as focal length, etc. This metadata may be associated with the image by storing the metadata in a file that contains the image data. Or the image data file may contain a pointer to a metadata file or vice versa.

The image and metadata may be transferred from the MICD to a memory storage device on a local computer (Step S106). Alternatively, the image and metadata may be uploaded to a server via the Internet directly from the MICD (Step S110). A user, who may be different from the person who captured the image, may add metadata to the metadata already associated with the image and may associate additional information and materials with the image (Step S108). The added metadata and information materials may contain files or links to files, such as audio files, video files, and text files. For example, an audio file may contain a verbal description of the image. A text file may contain the names of persons in the image. The image and its metadata and information materials may be uploaded to a server via the Internet (Step S110). In one embodiment, the metadata may be stored in a first location and the image may be stored in a second location. In another embodiment, at least a portion of the metadata is embedded in the digital image itself and includes a hyperlink to additional materials.

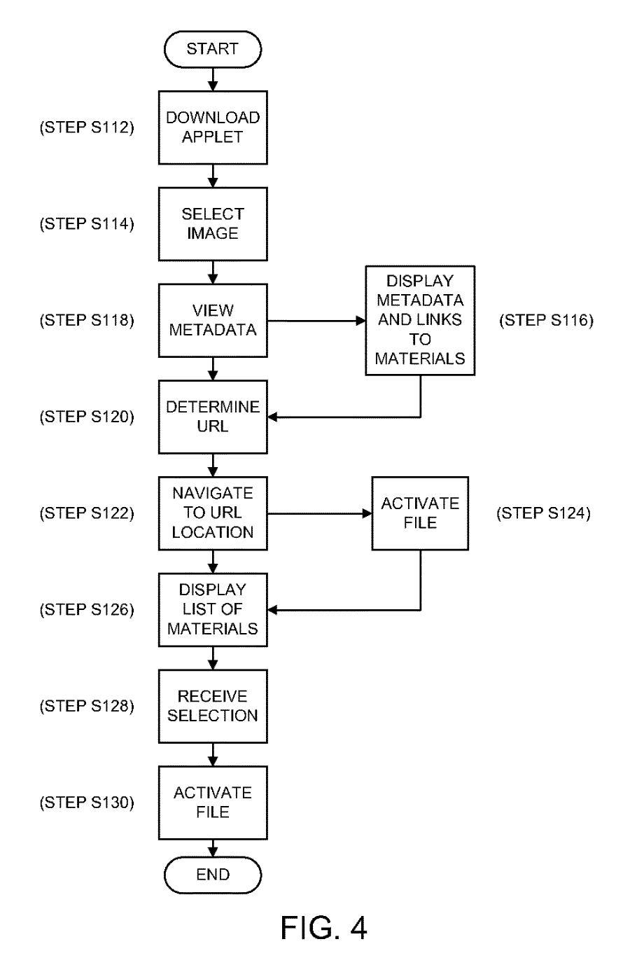

FIG. 4 is a flow chart of an exemplary process for selecting an image and viewing its metadata. A user may download an applet that has a metadata viewer (Step S112). The user selects an image that is displayed at a webpage (Step S114). In response to selection of the image, the applet may examine the metadata of the selected image (Step S118). In some embodiments, some or all of the metadata may be displayed with links to related information materials obtained from the metadata (Step S116). In some embodiments, the image is located on a computer of the user and when the image is selected, a hyperlink is activated that takes a user's web browser to a remote address designated by the hyperlink where the information materials are located

The applet may determine a URL in a field of the metadata of the selected image (Step S120). This URL may point to a website that has a list of links to information materials related to the image such as audio files, video files, and text files. Upon determining the URL, or in response to user input, the user's web browser may navigate to the website pointed to by the URL (Step S122). At the website, the web browser may automatically activate a file, such as an audio file, associated with the image, (Step S124). The browser displays a list of information materials associated with the image (Step S126). The user may then select a material, by clicking on a link to the material, or by voice command, or other known means (Step S128). Upon selection, the browser may then activate the selected file (Step S130).

One embodiment of the invention is a computer readable medium containing computer readable instructions, that when executed by the computer, cause the computer to perform functions for processing metadata related to an image. For example, the instructions may cause the computer to store the metadata associated with the image, evaluate the metadata, and perform an operation based on the metadata. The operations may include displaying information materials derived from the metadata. The operations may include playing a multimedia, video file and/or audio file when the image is selected. The operations may include accessing a website based on a URL included in the metadata. The URL may be an address of a website where the metadata and additional information materials associated with the image are located.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for managing digital images over a network comprising: receiving, at an imaging web server coupled to the network, a digital image file along with information associated to the digital image file, wherein the digital image file comprises data representing a digital image and the associated information includes at least one of a location of the imaging web server, a customer identification number, a date image was taken, a picture sequence number, a name of the digital image, a time the digital image was taken, location where the image was taken at, author/publisher of the digital image, subject matter of the digital image; keyword for the digital image file and a name of the imaging web server; parsing the associated information to extract multiple pieces of information from the associated information; coding the multiple pieces of extracted information of the associated information to create an identifier for the digital image file which the identifier may be the entire digital image; storing the digital image file and the identifier in a database coupled to the imaging web server; receiving a search request; querying the database with the search request; retrieving at least one requested digital image file matching the search request; and presenting at least one requested digital image corresponding to the at least one requested digital image file to a user.

2. The method as in claim one where the digital image is presented with textual information.

3. The method as in claim one where the digital image is presented with video information.

4. The method as in claim one where the digital image is presented with audio information.

5. The method as in claim one where the digital image is presented with hyperlink information.
